(19) United States
(12) Patent Application Publication
(10) Pub. No.: US 2025/0003463 A1
(43) Pub. Date: Jan. 2, 2025

(54) FRICTION MATERIAL

(71) Applicant: AKEBONO BRAKE INDUSTRY CO., LTD., Chuo-ku, Tokyo (JP)

(72) Inventors: Hiroshi YAMAMOTO, Chuo-ku, Tokyo (JP); Motoyuki MIYAJI, Chuo-ku, Tokyo (JP); Yuta WATANABE, Chuo-ku, Tokyo (JP)

(73) Assignee: AKEBONO BRAKE INDUSTRY CO., LTD., Chuo-ku, Tokyo (JP)

(21) Appl. No.: 18/707,703

(22) PCT Filed: Nov. 8, 2022
(86) PCT No.: PCT/JP2022/041613

§ 371 Date: May 6, 2024

(30) Foreign Application Priority Data
Nov. 10, 2021 (JP) 2021-183692

(51) Int. Cl. F16D 69/02

(52) U.S. Cl. CPC F16D 69/026; F16D 69/027

(57) ABSTRACT

The present invention relates to a friction material including: a friction modifier; a binder; and a fiber base material, in which as the friction modifier, cashew particles having an amount of eluted sulfate ions of 500 ppm or less and a titanate are contained, in which the cashew particles may have a content of 1.0 mass % to 7.0 mass %.

### TECHNICAL FIELD

The present invention relates to a friction material for use in automobiles, railway vehicles, industrial machines, and the like.

### BACKGROUND ART

In the related art, it is known that, when a friction material for use in a brake and the like is left in a parking brake state for a long time after being left in a low-temperature and high-humidity environment such as on a rainy day or early in the morning, or after being exposed to water during vehicle washing, a phenomenon in which a rotor and the friction material stick together due to rust, so-called seizure due to corrosion, occurs.

As a technique for preventing the seizure due to corrosion, for example, Patent Literature 1 discloses that porous inorganic particles having the ability to adsorb sulfate ions, which are the cause of the seizure due to corrosion, are used as a friction modifier.

### CITATION LIST

### Patent Literature

Patent Literature 1: JP2017-025286A

### SUMMARY OF INVENTION

### Technical Problem

However, in the friction material disclosed in Patent Literature 1, there is a limit to an amount of the sulfate ions that can be adsorbed, and it is thought that the prevention for seizure due to corrosion is insufficient.

The present invention has been made in view of the above circumstances, and an object thereof is to provide a friction material that can sufficiently prevent seizure due to corrosion.

### Solution to Problem

As a result of intensive studies, the inventors of the present invention have found that when the friction material contains cashew particles having an amount of eluted sulfate ions of 500 ppm or less and a titanate salt, the seizure due to corrosion can be sufficiently prevented. Thus, the present invention has been completed.

That is, the present invention relates to the following <1> to <3>.

<1> A friction material including:
a friction modifier;
a binder; and
a fiber base material, in which
as the friction modifier, cashew particles having an amount of eluted sulfate ions of 500 ppm or less and a titanate are contained.

<2> The friction material according to <1>, in which the cashew particles have a content of 1.0 mass % to 7.0 mass %.

<3> The friction material according to <1> or <2>, in which the titanate is potassium titanate.

### Advantageous Effects of Invention

The friction material according to the present invention can sufficiently prevent seizure due to corrosion.

### DESCRIPTION OF EMBODIMENTS

Hereinafter, the present invention will be described in detail, but these show examples of desirable embodiments, and the present invention is not specified in these contents. Note that, in the present description, “mass” has the same meaning as with “weight”.

A friction material according to the present embodiment contains a friction modifier, a binder, and a fiber base material.

Hereinafter, each component will be described in detail.

### <Friction Modifier>

The friction material according to the present embodiment contains, as the friction modifier, cashew particles having an amount of eluted sulfate ions of 500 ppm or less and a titanate.

### (Cashew Particles)

The cashew particles are obtained by crushing a polymerized and hardened cashew nut shell oil, and are sometimes referred to as cashew dust.

The cashew particles for use in the present embodiment have an amount of eluted sulfate ions of 500 ppm or less. When the friction material according to the present embodiment contains the cashew particles having an amount of eluted sulfate ions of 500 ppm or less, the amount of sulfate ions eluted into water, which are considered to be the cause of seizure due to corrosion, can be reduced, and as a result, the seizure due to corrosion is prevented.

The amount of eluted sulfate ions in the cashew particle for use in the present embodiment is preferably 400 ppm or less, more preferably 300 ppm or less, and still more preferably 200 ppm or less, from the viewpoint of preventing the seizure due to corrosion.

Note that, the above “ppm” means “ppm by mass”. In addition, the amount of eluted sulfate ions in the cashew particles can be measured, for example, in accordance with “JIS K 0102:2019 Annex 1 Barium sulfate nephelometric method of sulfate ions”.

In addition, the above cashew particles having a predetermined amount of eluted sulfate ions can be obtained, for example, by adjusting an amount of an acid catalyst remaining in the cashew particles. In addition, a commercially available product may also be used.

A content of the cashew particles in the entire friction material is preferably 1.0 mass % to 7.0 mass %, more preferably 1.0 mass % to 6.0 mass %, and still more preferably 1.0 mass % to 5.0 mass %, from the viewpoint of preventing the seizure due to corrosion. When the content of the cashew particles is 1.0 mass % or more, flexibility can be imparted to the friction material while maintaining a seizure due to corrosion prevention effect. When the content of the cashew particles is 7.0 mass % or less, heat resistance of the friction material is improved, and the amount of eluted sulfate ions in the friction material decreases, so that it is easier to obtain the seizure due to corrosion prevention effect.

An average particle diameter of the cashew particles is preferably 10 μm to 500 μm, and more preferably 100 μm to 300 μm. When the average particle diameter of the cashew particles is 10 μm or more, the cashew particles can be uniformly dispersed in the friction material, an appropriate transfer film is formed, and a friction coefficient is stabilized. When the average particle diameter of the cashew particles is 500 μm or less, strength and durability of the friction material are improved.

### (Titanate)

The friction material according to the present embodiment contains, as the friction modifier, a titanate.

When a abrasion powder is present at an interface between the friction material and a disc rotor, which is a mating material, the abrasion powder becomes a starting point for rust, which increases an seizure force. When the friction material according to the present embodiment contains a titanate, generation of the abrasion powder at a high temperature can be prevented, and as a result, the seizure due to corrosion is prevented. In particular, it is possible to prevent rust when a vehicle is left in a parking brake state for a long time after undergoing a thermal history.

Examples of the titanate include potassium titanate, lithium titanate, sodium titanate, calcium titanate, barium titanate, magnesium titanate, lithium potassium titanate, and magnesium potassium titanate. Among them, potassium titanate is preferred from the viewpoint of preventing the seizure due to corrosion.

Specific shapes of the titanate include a layer shape (scale shape), a columnar shape, a plate shape, a flake shape, a particle shape, and a spherical shape. Among them, a layer shape, a columnar shape, a plate shape, and a spherical shape are preferred, and a layer shape, a columnar shape, and a spherical shape are more preferred, from the viewpoint of stabilizing the friction coefficient.

A content of the titanate in the entire friction material is preferably 5 mass % to 35 mass %, more preferably 10 mass % to 30 mass %, and still more preferably 15 mass % to 25 mass %, from the viewpoint of preventing the seizure due to corrosion.

An average particle diameter of the titanate is preferably 1 μm to 200 μm, and more preferably 5 μm to 150 μm. When the average particle diameter of the titanate is 1 μm or more, abrasion resistance can be improved. When the average particle diameter of the titanate is 200 μm or less, the titanate can be uniformly dispersed in the friction material, and mechanical strength can be improved.

Note that, in the present description, the average particle diameter means a particle diameter (median diameter) equivalent to 50% of a volume-based cumulative percentage measured by a laser diffraction particle size distribution analyzer. In addition, the average particle diameter can also be measured by a sieving method.

### (Other Friction Modifiers)

Other friction modifiers are used to impart desired friction properties such as abrasion resistance, heat resistance, and fade resistance to the friction material.

Examples of the other friction modifiers include an inorganic filler, an organic filler, an abrasive, a solid lubricant, and a metal powder.

Examples of the inorganic filler include inorganic materials such as barium sulfate, calcium carbonate, calcium hydroxide, vermiculite, and mica. These may be used alone or in combination of two or more thereof.

The inorganic filler, together with the titanate, is used in an amount of preferably 40 mass % to 80 mass %, and more preferably 50 mass % to 70 mass %, in the entire friction material.

Examples of the organic filler include various rubber powders (a raw rubber powder, a tire powder, etc.), cashew dust, tire tread, and melamine dust. These may be used alone or in combination of two or more thereof.

The organic filler, together with the cashew particles, is used in an amount of preferably 1 mass % to 20 mass %, and more preferably 3 mass % to 15 mass %, in the entire friction material.

Examples of the abrasive include alumina, silica, magnesium oxide, zirconia, zirconium silicate, chromium oxide, triiron tetroxide (Fe₃O₄), and chromite. These may be used alone or in combination of two or more thereof.

The abrasive is used in an amount of preferably 1 mass % to 20 mass %, and more preferably 3 mass % to 15 mass %, in the entire friction material.

Examples of the solid lubricant include graphite, coke, antimony trisulfide, molybdenum disulfide, tin sulfide, and polytetrafluoroethylene (PTFE). These may be used alone or in combination of two or more thereof.

The solid lubricant is used in an amount of preferably 1 mass % to 20 mass %, and more preferably 3 mass % to 15 mass %, in the entire friction material.

Examples of the metal powder include powders of aluminum, tin, and zinc. These may be used alone or in combination of two or more thereof.

The metal powder is used in an amount of preferably 1 mass % to 10 mass %, and more preferably 1 mass % to 5 mass %, in the entire friction material.

From the viewpoint of sufficiently imparting the desired friction properties to the friction material, the friction modifier is used in an amount of preferably 60 mass % to 90 mass %, and more preferably 70 mass % to 90 mass %, in the entire friction material.

### <Binder>

As the binder, various commonly used binders can be used. Specific examples thereof include thermosetting resins such as a phenol resin, various modified phenol resins such as elastomer-modified phenol resins, a melamine resin, an epoxy resin, and a polyimide resin.

Examples of the elastomer-modified phenol resins include an acrylic rubber-modified phenol resin, a silicone rubber-modified phenol resin, and a nitrile rubber (NBR)-modified phenol resin. These may be used alone or in combination of two or more thereof.

From the viewpoint of moldability of the friction material, the binder is used in an amount of preferably 1 mass % to 20 mass %, and more preferably 3 mass % to 15 mass %, in the entire friction material.

### <Fiber Base Material>

As the fiber base material, various commonly used fiber base materials can be used. Specific examples include an organic fiber, an inorganic fiber, and a metal fiber.

Examples of the organic fiber include an aromatic polyamide (aramid) fiber and a flame-resistant acrylic fiber.

Examples of the inorganic fiber include a biosoluble inorganic fiber, a ceramic fiber, a glass fiber, a carbon fiber, and rock wool. Examples of the biosoluble inorganic fiber include biosoluble ceramic fibers such as a SiO₂—CaO—MgO-based fiber, a SiO₂—CaO—MgO—Al₂O₃-based fiber, and a SiO₂—MgO—SrO-based fiber, and biosoluble rock wool.

Examples of the metal fiber include a steel fiber. These may be used alone or in combination of two or more thereof.

From the viewpoint of ensuring sufficient strength of the friction material, the fiber base material is used in an amount of preferably 1 mass % to 20 mass %, and more preferably 3 mass % to 15 mass %, in the entire friction material.

It is preferable that the friction material according to the present invention does not contain a copper component. Note that, the expression “does not contain a copper component” means that the copper component is not contained as an active component for exhibiting functions such as abrasion resistance, but does not mean that, for example, any copper component, such as an impurity inevitably contained in the friction material with a small amount, is not contained. Note that, it is preferable that the copper component mixed as an impurity is 0.5 mass % or less from the viewpoint of an environmental load.

### <Method for Producing Friction Material>

The friction material according to the present embodiment can be produced by a known production process. For example, the friction material can be produced by blending the above components, and subjecting the blended material to steps such as preforming, hot molding, heating, and grinding according to a usual production method.

A method for producing a brake pad provided with the friction material generally includes the following steps:
(a) a step of molding a pressure plate into a predetermined shape by using a sheet metal press;
(b) a step of applying a degreasing treatment, a chemical conversion treatment, and a primer treatment to the above pressure plate and coating the pressure plate with an adhesive;
(c) a step of blending raw materials such as a friction modifier, a binder, and a fiber base material, performing sufficient homogenization by mixing, and molding at a predetermined pressure at room temperature to prepare a preformed body;
(d) a hot molding step of integrally fixing the preformed body and the pressure plate coated with the adhesive by applying a predetermined temperature and pressure (molding temperature: 130° C. to 180° C., molding pressure: 30 MPa to 80 MPa, molding time: 2 minutes to 10 minutes); and
(e) a step of performing after-cure (150° C. to 300° C., 1 hour to 5 hours) and finally performing finishing treatments such as grinding, scorching, and painting.

### EXAMPLES

The present invention will be specifically described by way of the following Examples, but the present invention is not limited thereto.

### Examples 1 to 10 and Comparative Examples 1 to 3

Blending materials shown in Table 1 were collectively charged into a mixer and mixed at room temperature for 5 minutes to obtain a mixture. The obtained mixture was subjected to the following steps of (i) preforming, (ii) hot molding, and (iii) heating and scorching to prepare a friction material. Note that, the average particle diameters of cashew particles and potassium titanate used as raw materials were 300 μm and 80 μm, respectively.

### (i) Preforming

The mixture was charged into a mold of a preforming press and molded at room temperature at 20 MPa for 10 seconds to prepare a preformed body.

### (ii) Hot Molding

The preformed body was charged into a hot molding mold, metal plates (pressure plates) coated with an adhesive in advance were stacked, and hot press molding was performed at 150° C. and 35 MPa for 6 minutes.

(iii) Heating and Scorching

The hot press molded body was subjected to a heat treatment at 250° C. for 3 hours and was then grinded.

Next, a surface of the hot press molded body was scorched and finished by a painting to obtain a friction material.

The friction materials obtained in Examples 1 to 10 and Comparative Examples 1 to 3 were evaluated as follows.

### <Seizure Due to Corrosion Property>

The friction material obtained above was processed into a test piece size, and a seizure due to corrosion property evaluation test was performed using a 1/7 scale tester under the following conditions. Note that, the mating material used was a cast iron rotor.
(1) High-temperature burnish: speed: 60 km/h, brake fluid pressure: 3.0 MPa, brake initial pad temperature: 400° C., number of brakes: 200 times
(2) Immersion in water: the friction material and the mating material are immersed in distilled water for 3 minutes
(3) Seizure: the friction material and the mating material are clamped with a load of 2.5 kN and left at room temperature for 16 hours
(4) Seizure force measurement: after being left unused, the load is released and the seizure force is measured

Five cycles were performed, with (1) to (4) as one cycle.

The seizure due to corrosion force (N) of each example obtained in the evaluation test was evaluated based on the following criteria. The results are shown in Table 2.
⊚: less than 5 N
∘: 5 N or more and less than 30 N
Δ: 30 N or more and less than 60 N
x: 60 N or more

### <Abrasion Resistance>

In accordance with JASO-C427, a friction material wear amount (mm) equivalent to 1000 braking times at a brake temperature of 400° C. was evaluated using a 1/7 scale tester based on the following criteria. The results are shown in Table 2.
⊚: less than 0.60 mm
∘: 0.60 mm or more and less than 0.80 mm
Δ: 0.80 mm or more and less than 1.00 mm
x: 1.00 mm or more

### <Yield>

During the hot molding, the hot press molded body after the hot molding was visually checked for blisters and cracks, and those with no blisters and cracks were determined to be good products, and a yield (%) was calculated using the following equation.

Yield (%)=[number of good products/number of prepared products]·100

The yield (%) was evaluated based on the following criteria. The results are shown in Table 2.
⊚: 100%
∘: 99.9% or more and less than 100%
Δ: 99.6% or more and less than 99.9%
x: less than 99.6%

TABLE 1
(mass %)

| | | | | Example | | | | | | |
|---|---|---|---|---|---|---|---|---|---|---|
| | | | | 1 | 2 | 3 | 4 | 5 | 6 | 7 |
| Blending | Binder | | Phenol resin | 8.0 | 8.0 | 8.0 | 8.0 | 8.0 | 8.0 | 8.0 |
| composition | Friction | Organic | Tire tread | 1.0 | 1.0 | 1.0 | 1.0 | 1.0 | 1.0 | 1.0 |
| | modifier | filler | Amount of sulfate ions in | 1.0 | 3.0 | 5.0 | 6.0 | 7.0 | — | — |
| | | | cashew particles: 200 ppm | | | | | | | |
| | | | Amount of sulfate ions in | — | — | — | — | — | 1.0 | 3.0 |
| | | | cashew particles: 400 ppm | | | | | | | |
| | | | Amount of sulfate ions in | — | — | — | — | — | — | — |
| | | | cashew particles: 600 ppm | | | | | | | |
| | | | Amount of sulfate ions in | — | — | — | — | — | — | — |
| | | | cashew particles: 1000 ppm | | | | | | | |
| | | Inorganic | Potassium titanate | 20.0 | 20.0 | 20.0 | 20.0 | 20.0 | 20.0 | 20.0 |
| | | filler | Calcium hydroxide | 6.0 | 6.0 | 6.0 | 6.0 | 6.0 | 6.0 | 6.0 |
| | | | Barium sulfate | 32.0 | 30.0 | 28.0 | 27.0 | 26.0 | 32.0 | 30.0 |
| | | | Mica | 5.0 | 5.0 | 5.0 | 5.0 | 5.0 | 5.0 | 5.0 |
| | | Abrasive | Zirconium silicate | 6.0 | 6.0 | 6.0 | 6.0 | 6.0 | 6.0 | 6.0 |
| | | | Triiron tetroxide | 5.0 | 5.0 | 5.0 | 5.0 | 5.0 | 5.0 | 5.0 |
| | | Solid | Tin sulfide | 3.0 | 3.0 | 3.0 | 3.0 | 3.0 | 3.0 | 3.0 |
| | | lubricant | Graphite | 6.0 | 6.0 | 6.0 | 6.0 | 6.0 | 6.0 | 6.0 |
| | | Metal | Zinc powder | 2.0 | 2.0 | 2.0 | 2.0 | 2.0 | 2.0 | 2.0 |
| | | powder | | | | | | | | |

| | | | | | | | | |
|---|---|---|---|---|---|---|---|---|
| Fiber base material | Aramid fiber | 3.0 | 3.0 | 3.0 | 3.0 | 3.0 | 3.0 | 3.0 |

| | | | | | | | |
|---|---|---|---|---|---|---|---|
| Biosoluble inorganic fiber | 2.0 | 2.0 | 2.0 | 2.0 | 2.0 | 2.0 | 2.0 |

| | | | | | | | |
|---|---|---|---|---|---|---|---|
| Total (mass %) | 100.0 | 100.0 | 100.0 | 100.0 | 100.0 | 100.0 | 100.0 |

(mass %)

| | | | | Example | | | Comparative Example | | |
|---|---|---|---|---|---|---|---|---|---|
| | | | | 8 | 9 | 10 | 1 | 2 | 3 |
| Blending | Binder | | Phenol resin | 8.0 | 8.0 | 8.0 | 8.0 | 8.0 | 8.0 |
| composition | Friction | Organic | Tire tread | 1.0 | 1.0 | 1.0 | 1.0 | 1.0 | 1.0 |
| | modifier | filler | Amount of sulfate ions in | — | — | — | — | — | 3.0 |
| | | | cashew particles: 200 ppm | | | | | | |
| | | | Amount of sulfate ions in | 5.0 | 6.0 | 7.0 | — | — | — |
| | | | cashew particles: 400 ppm | | | | | | |
| | | | Amount of sulfate ions in | — | — | — | 7.0 | — | — |
| | | | cashew particles: 600 ppm | | | | | | |
| | | | Amount of sulfate ions in | — | — | — | — | 7.0 | — |
| | | | cashew particles: 1000 ppm | | | | | | |
| | | Inorganic | Potassium titanate | 20.0 | 20.0 | 20.0 | 20.0 | 20.0 | — |
| | | filler | Calcium hydroxide | 6.0 | 6.0 | 6.0 | 6.0 | 6.0 | 16.0 |
| | | | Barium sulfate | 28.0 | 27.0 | 26.0 | 26.0 | 26.0 | 40.0 |
| | | | Mica | 5.0 | 5.0 | 5.0 | 5.0 | 5.0 | 5.0 |
| | | Abrasive | Zirconium silicate | 6.0 | 6.0 | 6.0 | 6.0 | 6.0 | 6.0 |
| | | | Triiron tetroxide | 5.0 | 5.0 | 5.0 | 5.0 | 5.0 | 5.0 |
| | | Solid | Tin sulfide | 3.0 | 3.0 | 3.0 | 3.0 | 3.0 | 3.0 |
| | | lubricant | Graphite | 6.0 | 6.0 | 6.0 | 6.0 | 6.0 | 6.0 |
| | | Metal | Zinc powder | 2.0 | 2.0 | 2.0 | 2.0 | 2.0 | 2.0 |
| | | powder | | | | | | | |

| | | | | | | | |
|---|---|---|---|---|---|---|---|
| Fiber base material | Aramid fiber | 3.0 | 3.0 | 3.0 | 3.0 | 3.0 | 3.0 |

| | | | | | | |
|---|---|---|---|---|---|---|
| Biosoluble inorganic fiber | 2.0 | 2.0 | 2.0 | 2.0 | 2.0 | 2.0 |

| | | | | | | |
|---|---|---|---|---|---|---|
| Total (mass %) | 100.0 | 100.0 | 100.0 | 100.0 | 100.0 | 100.0 |

TABLE 2

| | | | Example | | | | | | |
|---|---|---|---|---|---|---|---|---|---|
| | | | 1 | 2 | 3 | 4 | 5 | 6 | 7 |
| Evaluation | Seizure due to | After one cycle | 0.0 | 0.0 | 0.6 | 0.6 | 1.8 | 0.0 | 0.0 |
| | corrosion force | After two cycles | 0.0 | 1.8 | 2.2 | 2.7 | 4.8 | 0.8 | 1.0 |
| | [N] | After three cycles | 1.6 | 4.1 | 4.4 | 9.4 | 13.3 | 3.1 | 3.3 |
| | | After four cycles | 4.3 | 6.2 | 13.9 | 18.3 | 21.5 | 8.3 | 10.4 |
| | | After five cycles | 8.7 | 12.2 | 20.5 | 21.6 | 28.7 | 12.3 | 13.9 |
| | Friction material wear amount [mm] | | 0.49 | 0.54 | 0.55 | 0.64 | 0.73 | 0.50 | 0.53 |
| | Yield [%] | | 100.0 | 100.0 | 100.0 | 99.9 | 99.9 | 100.0 | 100.0 |
| Determination | Seizure due to | After one cycle | ⊚ | ⊚ | ⊚ | ⊚ | ⊚ | ⊚ | ⊚ |
| | corrosion force | After two cycles | ⊚ | ⊚ | ⊚ | ⊚ | ⊚ | ⊚ | ⊚ |
| | | After three cycles | ⊚ | ⊚ | ⊚ | ◯ | ◯ | ⊚ | ⊚ |
| | | After four cycles | ⊚ | ◯ | ◯ | ◯ | ◯ | ◯ | ◯ |
| | | After five cycles | ◯ | ◯ | ◯ | ◯ | ◯ | ◯ | ◯ |

| | | | | | | | |
|---|---|---|---|---|---|---|---|
| Friction material wear amount | ⊚ | ⊚ | ⊚ | ◯ | ◯ | ⊚ | ⊚ |
| Yield | ⊚ | ⊚ | ⊚ | ◯ | ◯ | ⊚ | ⊚ |

| | | | Example | | | Comparative Example | | |
|---|---|---|---|---|---|---|---|---|
| | | | 8 | 9 | 10 | 1 | 2 | 3 |
| Evaluation | Seizure due to | After one cycle | 0.9 | 1.1 | 3.2 | 7.4 | 7.7 | 7.7 |
| | corrosion force | After two cycles | 3.9 | 5.2 | 7.0 | 24.4 | 33.2 | 33.2 |
| | [N] | After three cycles | 10.0 | 12.1 | 20.4 | 39.8 | 52.5 | 52.5 |
| | | After four cycles | 15.7 | 20.1 | 25.2 | 57.4 | 102.6 | 102.6 |
| | | After five cycles | 23.5 | 23.7 | 29.8 | 89.8 | 122.0 | 122.0 |
| | Friction material wear amount [mm] | | 0.57 | 0.65 | 0.75 | 0.72 | 0.73 | 1.23 |
| | Yield [%] | | 100.0 | 99.9 | 99.9 | 99.9 | 99.9 | 99.6 |
| Determination | Seizure due to | After one cycle | ⊚ | ⊚ | ⊚ | ◯ | ◯ | ◯ |
| | corrosion force | After two cycles | ⊚ | ◯ | ◯ | ◯ | Δ | Δ |
| | | After three cycles | ◯ | ◯ | ◯ | Δ | Δ | Δ |
| | | After four cycles | ◯ | ◯ | ◯ | Δ | X | X |
| | | After five cycles | ◯ | ◯ | ◯ | X | X | X |

| | | | | | | |
|---|---|---|---|---|---|---|
| Friction material wear amount | ⊚ | ◯ | ◯ | ◯ | ◯ | X |
| Yield | ⊚ | ◯ | ◯ | ◯ | ◯ | Δ |

From the results in Table 2, it is found that the friction materials in Examples 1 to 10 can sufficiently prevent the seizure due to corrosion and have good abrasion resistance and yield.

Although the present invention has been described in detail with reference to a specific embodiment, it will be apparent to those skilled in the art that various changes and modifications can be made without departing from the spirit and the scope of the present 10 invention. The present application is based on a Japanese Patent Application (Japanese Patent Application No. 2021-183692) filed on Nov. 10, 2021, and the content thereof is incorporated herein by reference.

1: A friction material comprising:
a friction modifier;
a binder; and
a fiber base material, wherein
as the friction modifier, cashew particles having an amount of eluted sulfate ions of 500 ppm or less and a titanate are contained.

2: The friction material according to claim 1, wherein the cashew particles have a content of 1.0 mass % to 7.0 mass %.

3: The friction material according to claim 1, wherein the titanate is potassium titanate.

4: The friction material according to claim 2, wherein the titanate is potassium titanate.
